(19) United States
(12) Patent Application Publication
(10) Pub. No.: US 2015/0028714 A1
(43) Pub. Date: Jan. 29, 2015

(54) ROTATING ELECTRIC MACHINE

(71) Applicant: HONDA MOTOR CO., LTD., Tokyo (JP)

(72) Inventors: Yoshihisa Matsuoka, Utsunomiya-shi (JP); Takumi Shibata, Kitaadachi-gun (JP); Keisuke Azusawa, Utsunomiya-shi (JP)

(73) Assignee: HONDA MOTOR CO., LTD., Tokyo (JP)

(21) Appl. No.: 14/388,100

(22) PCT Filed: Feb. 22, 2013
(86) PCT No.: PCT/JP2013/054468

§ 371 Date: Sep. 25, 2014

(30) Foreign Application Priority Data
Mar. 29, 2012 (JP) 2012-076324

(51) Int. Cl. H02K 3/12

(52) U.S. Cl. CPC H02K 3/12
USPC 310/198

(57) ABSTRACT

Conductors comprising a U-phase coil, a V-phase coil and a W-phase coil are arranged in multiple slots in a stator forming a rotating electric machine. These U-phase coils, V-phase coils and W-phase coils are equipped with wave-wound parts, which have bridging parts on one end-face side of the stator core, and lap-wound parts, which are adjacent to the wave-wound parts and are formed so as to encircle the one end face and the other end face of the stator core. The wave-wound parts and the lap-wound parts are arranged so as to alternate in the winding direction of the conductors.

### TECHNICAL FIELD

The present invention relates to a rotary electric machine, which is operated as an electric motor or an electricity generator, having coils accommodated in slots of a stator for generating a rotating magnetic field.

### BACKGROUND ART

Heretofore, a rotary electric machine has been known having a stator formed in an annular shape, and a rotor that is inserted rotatably in a center portion of the stator, and in which a rotating magnetic field is generated by plural coils that are wound in slots of the stator for causing the rotor to rotate.

As a method for winding such coils in plural slots, a general wave winding method is known. The wave winding method involves winding the coils alternately to crossover one end and another end of the stator. Further, in the aforementioned wave winding, a two-layer type of winding is known by which coils of different phases are arranged with respect to the same slots. With such two-layer windings, for example, as disclosed in Japanese Laid-Open Patent Publication No. 2005-110431, when plural coils are arranged in the same slots, since coils of different phases are arranged in the slots, it is possible to generate magnetic fields smoothly and stably.

### SUMMARY OF INVENTION

Recently, there has been a demand for a rotary electric machine that is smaller in size. For example, as one countermeasure for reducing the size in the axial direction, it has been considered to shorten the crossover regions at which coils cross from certain ones of the slots to other ones of the slots, whereby the crossover heights of the coils with respect to the stator can be reduced.

However, in a rotary electric machine in which a two-layer winding structure is adopted as described above, in the event that a measure is taken to shorten the lengths of the crossover regions, although it is required to shorten the pitch at which the coils are arranged in two of the slots, upon shortening the aforementioned pitch, the coil pitch becomes shifted or offset with respect to the pitch of the magnetic poles of the rotor disposed in the interior of the stator, so that it becomes difficult to drive the rotary electric machine smoothly.

A general object of the present invention is to provide a rotary electric machine in which, by suppressing a crossover height at which the coils crossover the stator core, the rotary electric machine can be made smaller in size in the axial direction, and the rotary electric machine can be driven smoothly and stably.

The present invention is characterized by a rotary electric machine equipped with coils disposed in slots of a core, wherein the coils comprise:

wave windings, which are wound with respect to the slots at a first slot pitch; and

lap windings, which are wound adjacent to the wave windings at a second slot pitch,

wherein the wave windings and the lap windings are arranged alternately in a direction of the first and second slot pitches, and in at least a portion of the slots among the slots, respective windings of different phases are arranged together.

According to the present invention, a two-layer winding configuration is adopted, in which, in the coils, wave windings, which are wound with respect to the slots at a first slot pitch, are provided, and lap windings, which are wound adjacent to the wave windings at a second slot pitch, are provided. The wave windings and the lap windings are arranged alternately in a direction of the first and second slot pitches, and in at least a portion of the slots, respective windings of different phases are arranged together. Accordingly, compared to the two-layer configuration of the conventional technique, the distance in the pitch direction (winding direction) of the coils can be shortened, while additionally, a shift or offset between the pitch of the coils and the pitch of the magnetic poles of the rotating body that rotates with respect to the core can be prevented. As a result, the crossover height at which the coils crossover the ends of the core can be suppressed, along with enabling the rotary electric machine to be made smaller in size in the axial direction, and to be driven smoothly and stably.

### BRIEF DESCRIPTION OF DRAWINGS

FIG. 1 is an exterior perspective view showing a condition, in a rotary electric machine according to an embodiment of the present invention, in which conductors thereof are taken out;

FIG. 2 is a circuit diagram of conductors that constitute the rotary electric machine of FIG. 1;

FIG. 3 is a schematic cross sectional view showing an arrangement of U-phase coils and V-phase coils of conductors, which are arranged in slots of a stator of FIG. 2;

FIG. 4 is a plan view, with partial omission of the stator, showing a condition in which the conductors of FIG. 3 are arranged in respective slots; and

FIG. 5 is a schematic cross sectional view showing an arrangement of first and second coils of the U-phase coils of the conductors, according to a modification.

### DESCRIPTION OF EMBODIMENTS

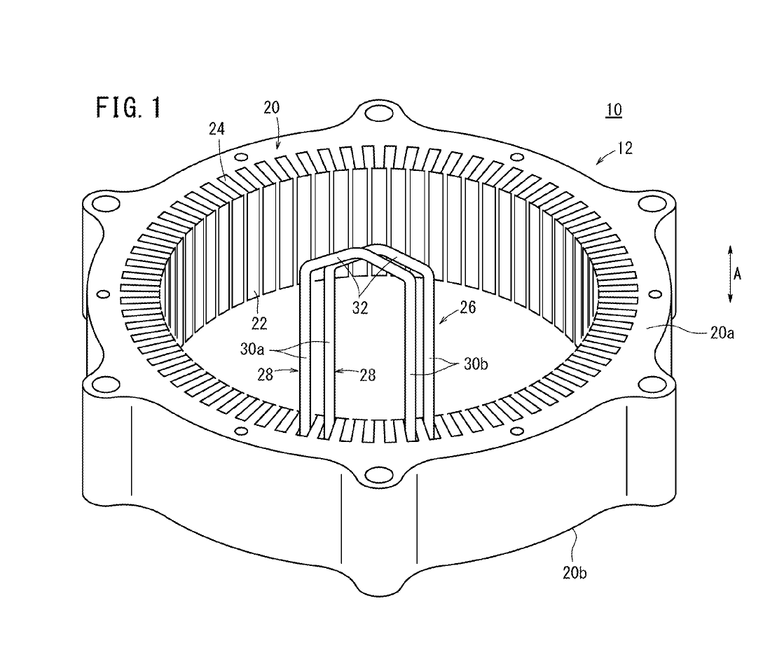

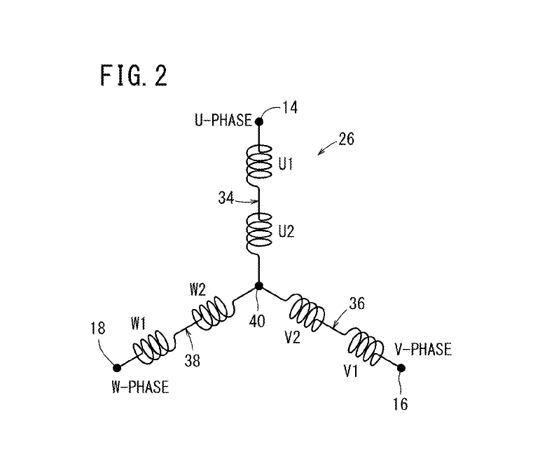

As shown in FIG. 1, a rotary electric machine 10, for example, is a 3-phase AC brushless motor, which includes an annular stator 12. A non-illustrated rotor is inserted rotatably in the interior of the stator 12. In the rotary electric machine 10, the rotor is driven rotatably based on electric power, which is supplied from a non-illustrated power source through terminals including a U-phase terminal 14, a V-phase terminal 16, and a W-phase terminal 18, respectively, as shown in FIG. 2.

The stator 12 is constituted from an annular stator core (core) 20, teeth 22, which are formed to project radially inward from the stator core 20, and plural conductors (coils) 26, which are installed in slots 24 that are disposed on outer circumferential sides with respect to the teeth 22.

The slots 24 are formed in plurality in the stator core 20 and are separated mutually by equal distances. The stator core 20 is formed with the slots 24 extending from one end surface 20a to another end surface 20b in the axial direction (the directions of the arrow A) of the stator core 20. The one end surface 20a and the other end surface 20b of the stator core 20 are formed substantially parallel to one another.

The conductors 26, for example, are made up from divided conductors 28, which are substantially U-shaped, for example, by bending rectangular conductive plates, which are rectangularly shaped in cross section, including respective pairs of straight line portions 30a, 30b, and respective top portions 32 where the ends of the straight line portions 30a, 30b are connected to each other. In addition, the divided conductors 28 are connected to any one of a U-phase terminal 14, a V-phase terminal 16, and a W-phase terminal 18, respectively, to thereby form the same phases (e.g., a U-phase, a V-phase, or a W-phase). More specifically, the distal ends of the straight line portions 30a, 30b of the divided conductors 28 are of an open shape, whereas the proximal ends thereof are connected together in a closed shape to thereby form the top portions 32.

Further, as shown in FIG. 2, the conductors 26 are composed of a U-phase coil 34, a V-phase coil 36, and a W-phase coil 38 in three phases. The U-phase coil 34, to which the U-phase terminal 14 is connected, is composed of first and second coils U1, U2, which are connected in series from one end portion connected to the U-phase terminal 14 to another end portion. The V-phase coil 36, to which the V-phase terminal 16 is connected, is composed of first and second coils V1, V2, which are connected in series from one end portion connected to the V-phase terminal 16 to another end portion. Furthermore, the W-phase coil 38, to which the W-phase terminal 18 is connected, is composed of first and second coils W1, W2, which are connected in series from one end portion connected to the W-phase terminal 18 to another end portion.

On the other hand, the other end ports of the U-phase coil 34, the V-phase coil 36, and the W-phase coil 38 are connected respectively to a neutral point 40. More specifically, the U-phase coil 34, the V-phase coil 36, and the W-phase coil 38 of the conductors 26 form a Y-shaped connection together mutually.

In addition, in the U-phase coil 34, the V-phase coil 36, and the W-phase coil 38, the voltages of first coils U1, V1, W1 thereof, which are arranged on sides of the U-phase terminal 14, the V-phase terminal 16, and the W-phase terminal 18, to which power is supplied, are comparatively high, whereas the voltages of the second coils U2, V2, W2 on the side of the neutral point 40 are relatively lower.

For the above-described conductors 26, instead of using the divided conductors 28, coil windings or the like may also be used.

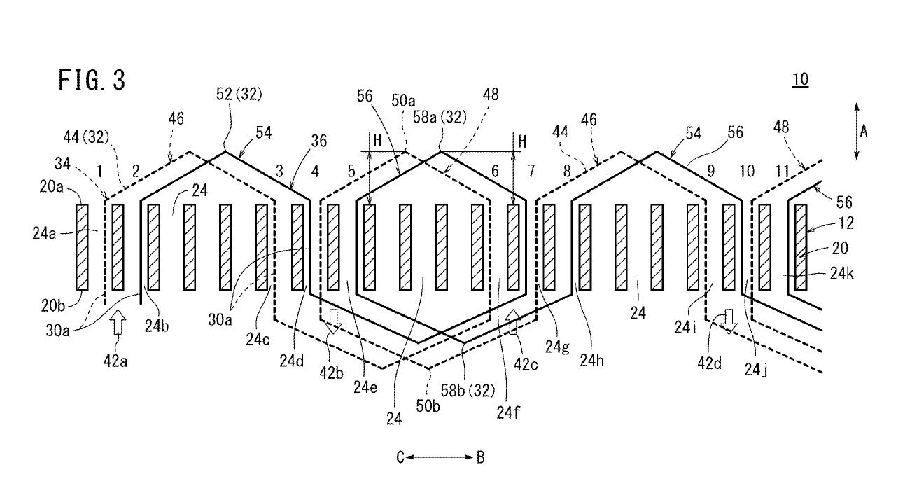

Next, a description will be given with reference to FIG. 3 concerning the arrangement of the conductors 26 in the respective slots of the stator 12. In the following description, among the 3-phase coils that make up the conductors 26, the arrangement of the U-phase coil 34 and the V-phase coil 36 will be described in detail, whereas a description concerning the arrangement of the W-phase coils 38 will be omitted. Further, FIG. 3, is a schematic illustration in which a cross-sectional surface perpendicular to the axial direction (in the directions of the arrow A) of the stator 12 is laid out, and with reference to FIG. 3, a case will be described in which plural slots 24 are disposed from a left side to a right side of the figure (in the direction of the arrow B), and the conductors 26 are wound sequentially in a winding direction toward the right side.

The arrows that point upwardly and downwardly in the central lower portion of the figure illustrate the positions and orientations of magnetic poles 42a to 42d in a non-illustrated rotor. The U-phase coils 34 are shown by the dashed line, whereas the V-phase coils 36 are shown by the solid line.

At first, as shown in FIG. 3, the U-phase coil 34 (shown by the dashed line in FIG. 3) is inserted into the first slot 24a from the other end surface 20b side of the stator core 20, and after being inserted therethrough to the one end surface 20a side of the stator core 20, the U-phase coil 34 skips over five adjacent ones of the slots 24 in the winding direction (the direction of the arrow B) with respect to the first slot 24a along the one end surface 20a side, is inserted into the third slot 24c, and passes therethrough to the other end surface 20b side. More specifically, the U-phase coil 34 is inserted into the first and third slots 24a, 24c, and a substantially U-shaped wave winding 46 is constituted thereby, including a crossover region 44 that crosses over the one end surface 20a side of the stator core 20.

Next, the U-phase coil 34 skips over six adjacent ones of the slots 24 in the winding direction (the direction of the arrow B) with respect to the third slot 24c, is inserted into the sixth slot 24f, and passes therethrough to the one end surface 20a side. Thereafter, the U-phase coil 34 skips over five of the slots 24 in an opposite direction (the direction of the arrow C) to the winding direction (the direction of the arrow B), and is inserted into the fourth slot 24d.

In addition, the U-phase coil 34 skips over six of the slots 24 again in the winding direction (the direction of the arrow B) from the other end surface 20b side of the fourth slot 24d, and is inserted into the seventh slot 24g adjacent to the sixth slot 24f. More specifically, concerning the U-phase coil 34, a lap winding 48 is constituted thereby, which is wound by one turn in covering relation to the one end surface 20a and the other end surface 20b of the stator core 20. In the lap winding 48, a pair of crossover regions 50a, 50b is formed respectively on the one end surface 20a and the other end surface 20b of the stator core 20.

Further, the U-phase coil 34, which is inserted into the seventh slot 24g, skips over five of the slots 24 again in the winding direction (the direction of the arrow B) on the one end surface 20a side of the stator core 20, is inserted into the ninth slot 24i, and after being inserted therethrough to the other end surface 20b, the U-phase coil 34 skips over six adjacent ones of the slots 24 in the winding direction (the direction of the arrow B) and is inserted into another non-illustrated slot.

In the foregoing manner, in the U-phase coil 34, wave windings 46, in which the coil is wound across five adjacent ones of the slots 24 on the one end surface 20a side of the stator core 20, and lap windings 48 adjacent to the wave windings 46, in which the coil is wound around the one end surface 20a and the other end surface 20b of the stator core 20, and with respect to the slots 24 of the adjacent wave windings 46, the coil is wound across five of the slots 24 on the one end surface 20a side and is wound across six of the slots 24 on the other end surface 20b side, are arranged alternately along the winding direction (in the direction of the arrow B).

Stated otherwise, the wave windings 46 of the U-phase coil 34 are wound at a 5-slot pitch along the winding direction (the direction of the arrow B) on the stator core 20, whereas the lap windings 48 are wound at a 5-slot pitch on the one end surface 20a side of the stator core 20, and at a 6-slot pitch on the other end surface 20b side of the stator core 20.

On the other hand, the V-phase coil 36 (shown by the solid line in FIG. 3) is inserted, from the other end surface 20b side of the stator core 20, into the second slot 24b, which lies adjacently in the winding direction (the direction of the arrow B) with respect to the first slot 24a in which the U-phase coil 34 is arranged, and after being inserted therethrough to the one end surface 20a side of the stator core 20, the V-phase coil 36 skips over five adjacent ones of the slots 24 in the winding direction (the direction of the arrow B) with respect to the second slot 24b along the one end surface 20a side, is inserted into the fourth slot 24d, and passes therethrough to the other end surface 20b side.

More specifically, the V-phase coil 36 is inserted into the second and fourth slots 24b, 24d, and a substantially U-shaped wave winding 54 is constituted thereby, including a crossover region 52 that crosses over the one end surface 20a side of the stator core 20.

Next, the V-phase coil 36 skips over six adjacent ones of the slots 24 in the winding direction (the direction of the arrow B) with respect to the fourth slot 24d, is inserted into the seventh slot 24g and passes therethrough to the one end surface 20a side, and thereafter, the V-phase coil 36 skips over five of the slots 24 in an opposite direction (the direction of the arrow C) to the winding direction (the direction of the arrow B), and is inserted into the fifth slot 24e. In addition, the V-phase coil 36 skips over six of the slots 24 again in the winding direction (the direction of the arrow B) from the other end surface 20b side of the fifth slot 24e, and is inserted into the eighth slot 24h.

More specifically, concerning the V-phase coil 36, a lap winding 56 is constituted thereby, which is wound by one turn in covering relation to the one end surface 20a and the other end surface 20b of the stator core 20. In the lap winding 56, a pair of crossover regions 58a, 58b is formed respectively on the one end surface 20a and the other end surface 20b of the stator core 20.

Further, the V-phase coil 36, which is inserted into the eighth slot 24h, skips over five of the slots 24 again in the winding direction (the direction of the arrow B) on the one end surface 20a side of the stator core 20, is inserted into the tenth slot 24j, and after being inserted therethrough to the other end surface 20b, the V-phase coil 36 skips over six adjacent ones of the slots 24 in the winding direction (the direction of the arrow B) and is inserted into another non-illustrated slot.

In the foregoing manner, in the V-phase coil 36, wave windings 54, in which the coil is wound across five adjacent ones of the slots 24 on the one end surface 20a side of the stator core 20, and lap windings 56 adjacent to the wave windings 54, in which the coil is wound around the one end surface 20a and the other end surface 20b of the stator core 20, and with respect to the slots 24 of the adjacent wave windings 54, the coil is wound across five of the slots 24 on the one end surface 20a side and is wound across six of the slots 24 on the other end surface 20b side, are arranged alternately along the winding direction (in the direction of the arrow B).

Stated otherwise, wave windings 54 of the V-phase coil 36 are wound at a 5-slot pitch along the winding direction (the direction of the arrow B) on the stator core 20, whereas the lap windings 56 are wound at a 5-slot pitch on the one end surface 20a side of the stator core 20, and at a 6-slot pitch on the other end surface 20b side of the stator core 20.

Further, in the fourth slot 24d and the seventh slot 24g, both the U-phase coil 34 and the V-phase coil 36, which are of different phases, are arranged together therein, thereby providing a two-layer winding configuration.

Similar to the cases of the U-phase coil 34 and the V-phase coil 36, for example, a W-phase coil 38 is provided in the slot adjacent to the second slot 24b, and wave windings, lap windings, and wave windings again are arranged alternately along the winding direction (the direction of the arrow B).

Further, in the above description, a configuration has been described in which, in the wave windings 46, 54, crossover regions 44, 52 are formed on the one end surface 20a side of the stator core 20. However, a configuration may also be provided in which such crossover regions are formed on the other end surface 20b side of the stator core 20.

Furthermore, in the above description, a case has been described in which, concerning the arrangement of the U-phase coil 34 and the V-phase coil 36, coils are utilized as the conductors 26. However, instead of such coils, in the event that divided conductors 28 are used as the conductors 26, the crossover regions 44, 50a, 52, 58a on the one end surface 20a and the other end surface 20b of the stator core 20 may be arranged so as to form the top portions 32 of the divided conductors 28, and regions that are inserted through the respective slots 24 may constitute the straight line portions 30a, 30b, and ends of the respective divided conductors 28, which are arranged adjacently, may be connected together electrically.

The winding direction (the direction of the arrow B) of the conductors 26 in the aforementioned stator 12 is in the same direction as the pitch direction of the slots 24.

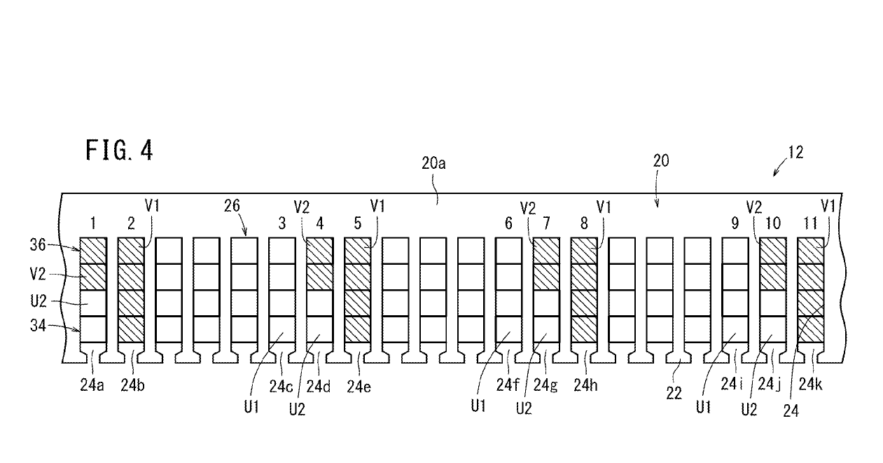

Further, as shown in FIG. 4, in the first, the fourth, the seventh, and the tenth slots 24a, 24d, 24g, 24j of the stator 12, the U-phase coil 34 and the V-phase coil 36, which are of different phases, are arranged together in the same slots. In this case, in the U-phase coil 34 and the V-phase coil 36, second coils U2, V2, which are disposed on the side of the neutral point 40, are arranged together respectively, and the second coil V2 is disposed inside of the slots 24 on an outer circumferential side with respect to the second coil U2.

On the other hand, in the third, the sixth, and the ninth slots 24c, 24f, 24i, only the U-phase coil 34 is arranged therein, and in this case, only the first coil U1, which is disposed on the side of the U-phase terminal 14, is arranged in the U-phase coil 34. Further, in the second, the fifth, the eighth, and the eleventh slots 24b, 24e, 24h, 24k only the V-phase coil 36 is arranged therein, and in this case, only the first coil V1, which is disposed on the side of the V-phase terminal 16, is arranged in the V-phase coil 36.

In the foregoing manner, according to the present embodiment, when the conductors 26 are installed with respect to the plural slots 24 that are formed in the stator core 20, the U-phase coil 34, the V-phase coil 36, and the W-phase coil 38, which are of different phases, are inserted and wound initially in mutually different adjacent slots 24. Together therewith, wave windings 46, 54 having crossover regions 44, 52 only on the one end surface 20a side of the stator core 20, and lap windings 48, 56, in which pairs of crossover regions 50a, 50b, 58a, 58b are formed by being wound, respectively, on the one end surface 20a and the other end surface 20b of the stator core 20, are arranged in the circumferential direction of the stator core 20, and more specifically, are arranged alternately along the winding direction (in the direction of the arrow B) of the U-phase coil 34, the V-phase coil 36, and the W-phase coil 38.

Consequently, windings can be provided in which, on the one end surface 20a side of the stator core 20, the pitch of the conductors 26 (i.e., the distance along the winding direction) is shorter than on the other end surface 20b side. Therefore, the conductors 26 are wound alternately in a positive direction and a reverse direction with respect to the winding direction (the direction of the arrow B) of the conductors 26, and together therewith, the occurrence of shifting or offset between the pitch of the conductors 26 and the pitch of the magnetic poles 42a to 42d is prevented.

More specifically, compared to the two-layer winding structure of the rotary electric machine according to the conventional technology, even in the event that the winding pitch of the conductors 26 is shortened, shifting or offset of the winding pitch with respect to the pitch of the magnetic poles 42a to 42d can be prevented, and the rotary electric machine 10 can be driven smoothly to obtain a desired output.

Further, by shortening the pitch of the conductors 26, the height H (see FIG. 3) can be suppressed in the crossover regions 44, 50a, 50b, 52, 58a, 58b on the one end surface 20a and the other end surface 20b of the stator core 20, and the dimension in the axial directions of the arrow A of the rotary electric machine 10 including the stator core 20 can be minimized.

Furthermore, when any two of the U-phase coil 34, the V-phase coil 36, and the W-phase coil 38 are arranged with respect to the same slot, as is the case in the fourth, the seventh, and the tenth slots 24d, 24g, 24j in the stator core 20, the second coils U2, V2, W2, which are of a low voltage and are arranged on the side of the neutral point 40 in FIG. 2, may be disposed adjacently alongside one another. Accordingly, the insulation compensation level of the insulating members disposed between coils of different phases can be suppressed.

Further still, by utilizing the divided conductors 28 as the conductors 26, the straight line portions 30a, 30b on open sides thereof can be assembled easily with respect to the stator 12 simply by being inserted into respective slots 24. In addition, since the top portions 32 can be configured as the crossover regions 44, 50a, 52, 58a without requiring any changes thereto, ease of assembly of the conductors 26 can be enhanced.

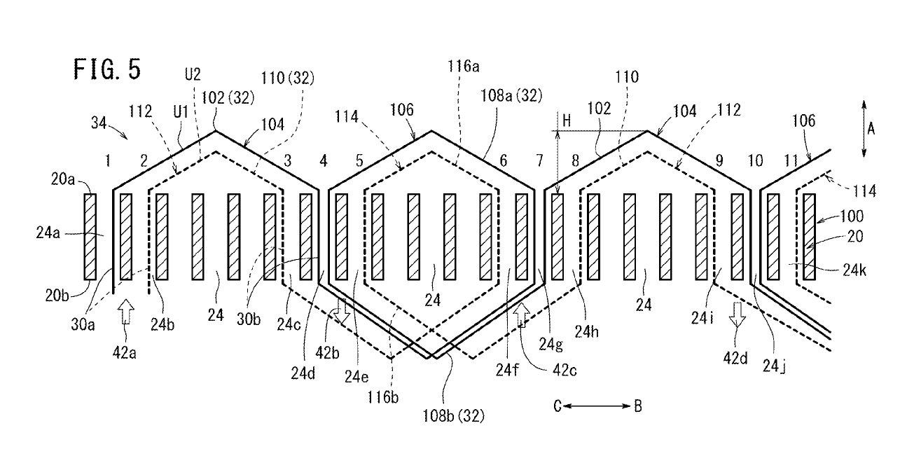

Further, the conductors 26 are not limited to the above-described case in which the U-phase coil 34 and the V-phase coil 36 of different phases are wound with a 1-slot offset therebetween in adjacent slots 24 along the winding direction (the direction of the arrows B). For example, as in a stator 100 shown in FIG. 5, the second coils U2, which are of the same phase, may be arranged on the inner side of the first coils U1 of the U-phase coil 34. In FIG. 5, the first coils U1 are illustrated by solid lines, and the second coils U2 are illustrated by dashed lines.

At first, in the stator core 20, the first coil U1 (shown by the solid line in FIG. 5) is inserted into the first slot 24a, and after being inserted therethrough from the other end surface 20b to the one end surface 20a side of the stator core 20, the first coil U1 skips over six adjacent ones of the slots 24 in the winding direction (the direction of the arrow B) with respect to the first slot 24a along the one end surface 20a side, is inserted into the fourth slot 24d, and passes therethrough to the other end surface 20b side.

More specifically, the first coil U1 is inserted into the first and fourth slots 24a, 24d, and a first wave winding 104 is constituted thereby including a crossover region 102 that crosses over the one end surface 20a side of the stator core 20.

The first coil U1 skips over six adjacent ones of the slots 24 in the winding direction (the direction of the arrow B) the other end surface 20b side with respect to the fourth slot 24d on the fourth slot 24d side, is inserted into the seventh slot 24g, and passes therethrough to the one end surface 20a side, and thereafter, the first coil U1 skips over six of the slots 24 in an opposite direction (the direction of the arrow C) to the winding direction (the direction of the arrow B), and is inserted into the fourth slot 24d.

In addition, the first coil U1 skips over six of the slots 24 again in the winding direction (the direction of the arrow B) from the other end surface 20b side of the fourth slot 24d, and is inserted into the seventh slot 24g. More specifically, concerning the first coil U1, a first lap winding 106 is constituted thereby, which is wound by one turn in covering relation to the one end surface 20a and the other end surface 20b of the stator core 20.

Further, the first coil U1, which is inserted into the seventh slot 24g, skips over six of the slots 24 again in the winding direction (the direction of the arrow B) on the one end surface 20a side of the stator core 20, is inserted into the tenth slot 24j, and after having made another first wave winding 104 by being inserted therethrough to the other end surface 20b, the first coil U1 skips over six adjacent ones of the slots 24 in the winding direction (the direction of the arrow B), is inserted into another non-illustrated slot, and another first lap winding 106 is made.

In the foregoing manner, in the first coil U1, first wave windings 104, in which the coil is wound across six adjacent ones of the slots 24 on the one end surface 20a side of the stator core 20, and first lap windings 106 adjacent to the first wave windings 104, in which the coil is wound around the one end surface 20a and the other end surface 20b of the stator core 20, and with respect to the slots 24 of the adjacent first wave windings 104, the coil is wound across six of the slots 24 on the one end surface 20a side and is wound across six of the slots 24 on the other end surface 20b side, are arranged alternately along the winding direction (in the direction of the arrow B). The first lap winding 106 includes a pair of crossover regions 108a, 108b.

More specifically, the first coil U1 is wound on the stator core 20 at a 6-slot pitch along the winding direction (in the direction of the arrow B).

On the other hand, the second coil U2 is inserted, from the other end surface 20b side of the stator 100, into the second slot 24b, which lies adjacently in the winding direction (the direction of the arrow B) with respect to the first slot 24a in which the first coil U1 is arranged, and after being inserted therethrough to the one end surface 20a side of the stator 100, the second coil U2 skips over four adjacent ones of the slots 24 in the winding direction (the direction of the arrow B) with respect to the second slot 24b along the one end surface 20a side, is inserted into the third slot 24c, and passes therethrough to the other end surface 20b side. More specifically, the second coil U2 is inserted into the second and third slots 24b, 24c, and a second wave winding 112 is constituted thereby, including a crossover region 110 that crosses over the one end surface 20a side of the stator 100. In addition, the slot pitch of the second wave winding 112 is formed with a 4-slot pitch, which is smaller than that of the first wave winding 104, which is formed with a 6-slot pitch.

Stated otherwise, the second wave windings 112 are arranged inside of the first wave windings 104.

Next, the second coil U2 skips over six adjacent ones of the slots 24 in the winding direction (the direction of the arrow B) with respect to the third slot 24c, is inserted into the sixth slot 24f and passes therethrough to the one end surface 20a side, and thereafter, the second coil U2 skips over four of the slots 24 in an opposite direction (the direction of the arrow C) to the winding direction (the direction of the arrow B), and is inserted into the fifth slot 24e. In addition, the second coil U2 skips over six of the slots 24 again in the winding direction (the direction of the arrow B) from the other end surface 20b side of the fifth slot 24e, and is inserted into the adjacent eighth slot 24h. More specifically, concerning the second coil U2, a second lap winding 114 is constituted thereby, which is wound by one turn in covering relation to the one end surface 20a and the other end surface 20b of the stator 100.

The second lap winding 114 is formed with a 4-slot pitch, which is smaller than that of the first lap winding 106 that is formed with a 6-slot pitch, and the second lap winding 114 includes a pair of crossover regions 116a, 116b, both of which are arranged inside of the first lap winding 106.

Further, the second coil U2, which is inserted into the eighth slot 24h, skips over four of the slots 24 again in the winding direction (the direction of the arrow B) on the one end surface 20a side of the stator core 20, is inserted into the ninth slot 24i, and after having made another second wave winding 112 by being inserted therethrough to the other end surface 20b, the second coil U2 skips over six adjacent ones of the slots 24 in the winding direction (the direction of the arrow B), is inserted into another non-illustrated slot, and another second lap winding 114 is made.

In the foregoing manner, in the second coil U2, second wave windings 112, in which the coil is wound across four adjacent ones of the slots 24 on the one end surface 20a side of the stator core 20, and second lap windings 114 adjacent to the second wave windings 112, in which the coil is wound around the one end surface 20a and the other end surface 20b of the stator core 20, and with respect to the slots 24 of the adjacent second wave windings 112, the coil is wound across four of the slots 24 on the one end surface 20a side and is wound across six of the slots 24 on the other end surface 20b side, are arranged alternately along the winding direction (in the direction of the arrow B).

Further, although with the fourth, the seventh, and the tenth slots 24d, 24g, 24j, respective first coils U1 of a high voltage are disposed together, since the first coils U1 are of the same phase, there is no need to provide an insulating material therebetween. On the other hand, with respect to slots in which only the second coils U2 are arranged, as in the case of the second, the third, the fifth, the sixth, the eighth, the ninth, and the eleventh slots 24b, 24c, 24e, 24f, 24h, 24i, 24k, two-layer windings are provided therein in which the second coils V2, W2 of different phases are arranged. At this time, even though the second coils U2 of different phases are disposed together in the same slots, since the voltages of the second coils U2, V2, W2 are lower than those of the first coils U1, V1, W1, the insulation compensation level of the insulating material provided between the second coils U2 of one phase and the second coils V2, W2 of other phases can be suppressed.

Further, although in the above description, a case has been described in which the U-phase coil 34 is arranged from among the three phases, since the same arrangements also apply to the cases of the V-phase coil 36 and the W-phase coil 38, detailed descriptions of such cases are omitted.

With the stator 100 according to the modification, since among the U-phase coil 34, the V-phase coil 36, and the W-phase coil 38, which are of the same phase, the second coils U2 (V2, W2) can be arranged in proximity on the inner side of the first coils U1 (V1, W1), compared to the rotary electric machine 10 of the aforementioned main embodiment, the crossover height H (see FIG. 5) of the conductors 26 on the side of the one end surface 20a of the stator 100 can be further suppressed, the axial dimension of the rotary electric machine 10 including the stator 100 is reduced, and the rotary electric machine 10 can be made still smaller in size.

The rotary electric machine according to the present invention is not limited to the above embodiment, and various additional or modified structures may be adopted therein without departing from the scope and essence of the invention as set forth in the appended claims.

1.-6. (canceled)

7. A rotary electric machine that is equipped with coils disposed in slots of a core, wherein the coils comprise:
wave windings, which are wound with respect to the slots at a first slot pitch; and
lap windings, which are wound adjacent to the wave windings at a second slot pitch,
wherein the wave windings and the lap windings are arranged alternately in a direction of the first and second slot pitches, and in at least a portion of the slots among the slots, respective windings of different phases are arranged together,
wherein the coils are U-shaped divided conductors including respective pairs of straight line portions, in each of the divided conductors, one of the straight line portions being inserted into the slot in which respective windings of same phase are arranged, and another of the straight line portions being inserted into the slot in which respective windings of different phases are arranged, and
wherein in a predetermined circumferential direction in the core, the other straight line portions in the windings of the same phase are all disposed on an outer circumferential side with respect to a midpoint in a radial direction.

8. The rotary electric machine according to claim 7, wherein in the coils, windings of the same phase are arranged in a distributed manner in plural adjacent slots, and in at least a portion of the slots among the slots, respective windings of the same phase are arranged together.

9. The rotary electric machine according to claim 8, further comprising:
a first end portion, which is provided at a third slot pitch a crossover region of the core ; and
a second end portion, which is wound at a smaller pitch than the third slot pitch, and provided inside of the third slot pitch,
wherein the first and second end portions are provided respectively for each of the phases.

10. The rotary electric machine according to claim 7, wherein the divided conductors are formed in a closed shape on one crossover side of the core, and are formed in an open shape on another crossover side of the core.

11. The rotary electric machine according to claim 7, wherein ends of the windings of each of the phases are connected to terminals, and other ends thereof form Y-shaped connections that are connected to a same neutral point, windings of different phases being connected to terminals of each of the phases, respectively.

12. The rotary electric machine according to claim 8, wherein ends of the windings of each of the phases are connected to terminals, and other ends thereof form Y-shaped connections that are connected to a same neutral point, windings of the same phase being connected to neutral point sides from the terminal sides of respective phases.
